(19) United States
(12) Patent Application Publication
(10) Pub. No.: US 2008/0101174 A1
(43) Pub. Date: May 1, 2008

(54) OPTIMAL POWER CALIBRATION METHOD AND DATA RECORDING APPARATUS USING THE SAME

(75) Inventor: Cheng-Hui Lin, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/553,481

(22) Filed: Oct. 27, 2006

(51) Int. Cl. G11B 20/10

(52) U.S. Cl. 369/47.5

(57) ABSTRACT

An optimal power calibration method includes steps of: performing a first optimal power calibration procedure at a first power calibration area with a first recording speed to obtain a first optimal power level corresponding to the first recording speed; performing a second optimal power calibration procedure at a second power calibration area with a second recording speed to obtain a second optimal power level corresponding to the second recording speed, the second recording speed being higher than the first recording speed; and determining an optimal recording power level for recording data on a disc at a predetermined speed based on the first optimal power level and the second optimal power level.

### BACKGROUND OF THE INVENTION

1. Field of the Invention

This invention relates to data recording apparatuses and, more particularly, to a method for calibrating an optimal recording power level of a data recording apparatus.

2. Description of Related Art

Recordable discs (DVD−R/RW, DVD+R/RW or CD+R/RW) are currently popular storage media in the consumer electronics market. Related data recording apparatuses for recording data onto the recordable discs are also widely used. Generally, the data recording apparatuses have to undergo an optimal power calibration (OPC) procedure to obtain required optimal recording power levels before recording data onto the recordable discs. A typical disc includes a lead-in area, a data area, and a lead-out area. A typical data recording apparatus includes a pick-up unit for emitting a laser beam onto the disc to record data onto the disc. A typical OPC procedure is performed at a power calibration area (PCA) that is arranged on an inner area of the disc. When performing the OPC procedure, the pick-up unit emits laser beams with different power levels to record calibration data onto the PCA. Then reflected light beams reflected from the disc are used to compute the power level optimal for recording data onto the disc.

Because the PCA is arranged on the inner area of the disc, a recording speed during the OPC procedure is limited to a relatively low speed. In general, when recording data on tracks at an outer area of the disc, a relatively high recording speed is employed. The higher the recording speed is, the greater the corresponding recording power level is needed. Traditionally, an optimal recording power level for recording data at the relatively high speed is obtained by calculations based on the optimal recording power level obtained during the OPC procedure. However, the optimal recording power level for recording data at the relatively high speed by such a way tends to be improper due to errors.

Therefore, a method for calibrating the optimal recording power level is desired.

### SUMMARY OF THE INVENTION

An optimal power calibration method includes steps of: performing a first optimal power calibration procedure at a first power calibration area with a first recording speed to obtain a first optimal power level corresponding to the first recording speed; performing a second optimal power calibration procedure at a second power calibration area with a second recording speed to obtain a second optimal power level corresponding to the second recording speed, the second recording speed being higher than the first recording speed; and determining an optimal recording power level for recording data on a disc at a predetermined speed based on the first optimal power level and the second optimal power level.

A data recording apparatus for recording data on a disc includes an optical pick-up unit, an analog signal processor, a digital signal processor, and a firmware. The optical pick-up unit is constructed for emitting light beams to be focused on the disc, detecting reflected light beams from the disc and for generating electrical signals based on the reflected light beams. The analog signal processor is constructed for generating radio frequency signals based on the electrical signals. The digital signal processor is constructed for converting the radio frequency signals into digital signals. The firmware is connected to the digital signal processor, and constructed for sending commands to the digital signal processor. The commands is then transformed to analog signals by the digital signal processor and then fed to the analog signal processor to control the optical pick-up unit to emit light beams to perform a first optimal power calibration procedure at a first recording speed at a first power calibration area to obtain a first optimal power level and perform a second optimal power calibration procedure at a second recording speed at a second power calibration area to obtain a second optimal power level. The first power calibration area is arranged on an inner area of the disc, and the second power calibration area is arranged at an outer area of the disc. The second recording speed is higher than the first recording speed.

A storage medium for recording a computer-executable program, the program has a computer executable steps of: performing a first optimal power calibration procedure at a first power calibration area with a first recording speed to obtain a first optimal power level corresponding to the first recording speed; performing a second optimal power calibration procedure at a second power calibration area with a second recording speed to obtain a second optimal power level corresponding to the second recording speed, the second recording speed being higher than the first recording speed; and determining an optimal recording power level for recording data on a disc at a predetermined speed based on the first optimal power level and the second optimal power level.

Other advantages and novel features will become more apparent from the following detailed description of preferred embodiments when taken in conjunction with the accompanying drawings, in which:

### BRIEF DESCRIPTION OF THE DRAWINGS

Many aspects of the data recording apparatus and the optimal power calibration method thereof can be better understood with reference to the following drawings. The components in the drawings are not necessarily to scale, the emphasis instead being placed upon clearly illustrating the principles of the present data recording apparatus and the present optimal power calibration method. Moreover, in the drawings, like reference numerals designate corresponding parts throughout the several views.

FIG. 1 is a block diagram of a data recording apparatus in accordance with an exemplary embodiment, the data recording apparatus including an optical pick-up unit;

FIG. 2 is a schematic diagram illustrating an optical system of the optical pick-up unit of FIG. 1;

FIG. 3 is a schematic diagram illustrating a structure of a DVD−R;

FIG. 4 is a schematic diagram illustrating a structure of a DVD+R;

FIG. 5 is a flow chart illustrating a calibrating procedure of an optimal power calibration method before recording in accordance with an exemplary embodiment;

FIG. 6 is a flow chart illustrating a calibrating procedure of an optimal power calibration method during recording in accordance with an exemplary embodiment;

FIG. 7 is a schematic diagram illustrating how to calculate an optimal power level for recording data on a specific position of a disc in the calibrating procedure of FIG. 5;

FIG. 8 is a characteristic curve illustrating values of a beta variable when recording data on different physical sectors of the disc at a relatively high recording speed with recording power levels obtained under a traditional optimal power calibration method;

FIG. 9 a characteristic curve illustrating values of the beta variable when recording data on different physical sectors of the disc at the relatively high recording speed with recording power levels obtained under the optimal power calibration method of FIG. 5 and FIG. 6; and

FIG. 10 is a characteristic curve illustrating values of parity inner error (PIE) when recording data on different physical sectors of the disc at the relatively high recording speed with the recording power levels obtained under the traditional optimal power calibration method; and

FIG. 11 is a characteristic curve illustrating values of the PIE when recording data on different physical sectors of the disc at the relatively high recording speed with the recording power levels obtained under the optimal power calibration method of FIG. 5 and FIG. 6.

### DETAILED DESCRIPTION OF THE INVENTION

Reference will now be made to the drawings to describe the preferred embodiment of the present data recording apparatus and the present optimal power calibration method, in detail.

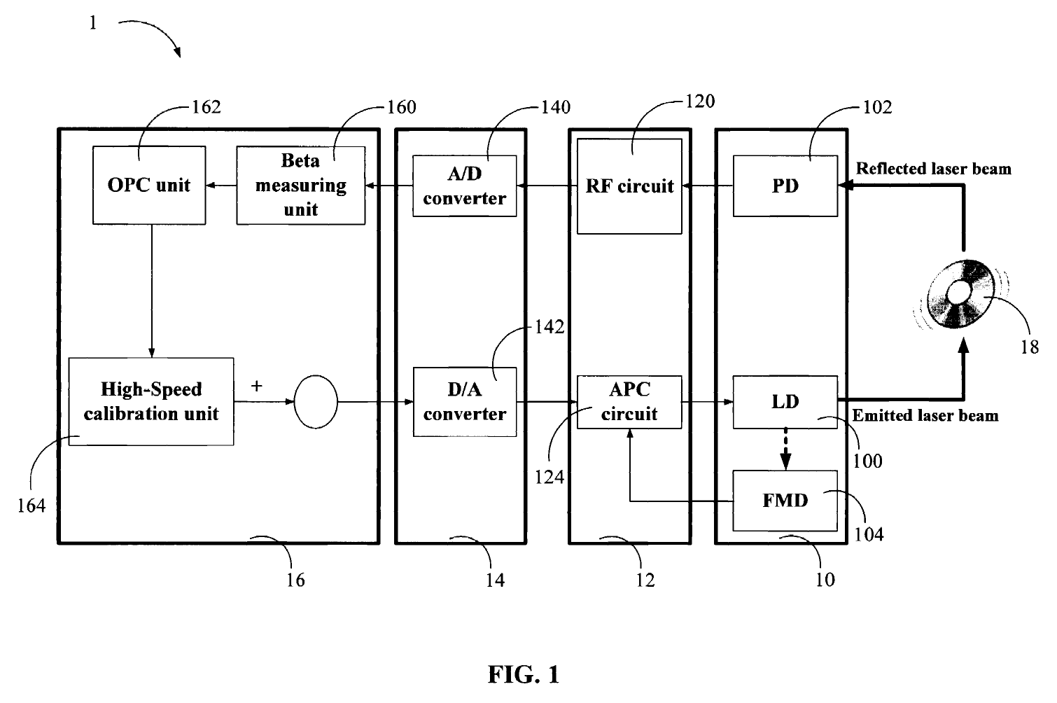

Referring to FIG. 1, a data recording apparatus 1 is used for recording data onto a disc 18, and includes an optical pick-up unit (OPU) 10, an analog signal processor (ASP) 12 connected to the OPU 10, a digital signal processor (DSP) 14 connected to the ASP 12, and a firmware 16 connected to the DSP 14.

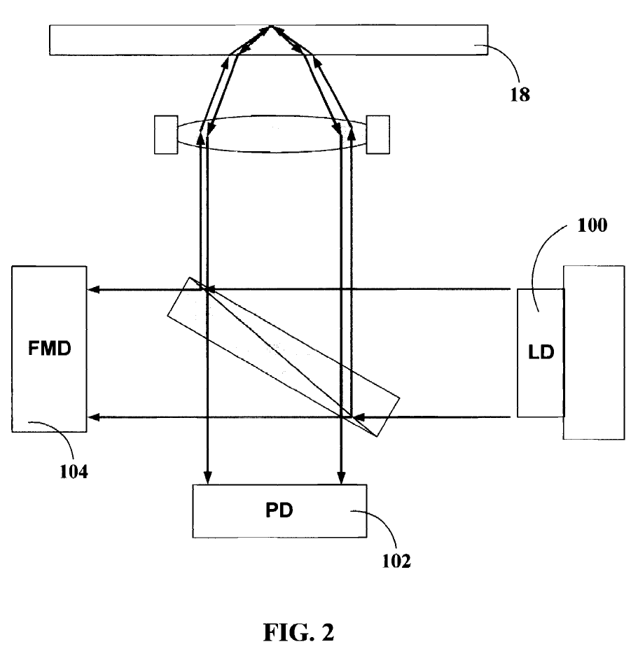

Referring also to FIG. 2, a schematic diagram showing an optical system of the OPU 10 is illustrated. The OPU 10 includes a laser diode (LD) 100 for emitting a laser beam (hereinafter referred as to emitted laser beam) onto the disc 18 for recording data onto the disc 18 and reproducing data from the disc 18, a photo diode (PD) 102 for detecting a laser beam reflected from the disc 18 (hereinafter referred to as reflected laser beam) and generating electrical signals to be transmitted to the ASP 12, and a front monitor diode (FMD) 104 for detecting the emitted laser beam and generating an FMD signal to be transmitted to the ASP 12. The PD 102 may be a 4-divided photo diode or an 8-divided photo diode. Generally, if the PD 102 is a 4-divided photo diode, the electrical signals generated by the PD 102 include A, B, C, and D signal groups. The A, B, C, and D signal groups are used as control signals for controlling operations of the data recording apparatus 1. For example, a tilt error (TE) signal used for correcting tilts of the disc 18 with respect to the emitted laser beam is obtained by subtracting (C+D) from (A+B), and a focus error (FE) signal used for correcting focus errors of the emitted laser beam is obtained by subtracting (B+D) from (A+C).

The ASP 12 includes a radio-frequency (RF) circuit 120 for receiving the electrical signals to generate an RF signal (also known as high-frequency signal, HF signal) to be transmitted to the DSP 14, and an automatic power control (APC) circuit 122 for automatically controlling a power level of the laser beam emitted by the LD 100. The RF signal is a sum of the A, B, C, and D signal groups.

The DSP 14 is used for controlling the ASP 12 to adjust the power level of the laser beam emitted by the LD 100, and includes an analog-to-digital (A/D) converter 140 for converting the RF signal to a first digital signal and transmitting the first digital signal to the firmware 16, and a digital-to-analog (D/A) converter 142 for receiving a second digital signal from the firmware 16, converting the second digital signal into an analog signal and transmitting the analog signal to the ASP 12 controlling the ASP 12 to adjust the power level of the laser beam emitted by the LD 100.

The firmware 16 is used for performing optimal power calibration procedures to obtain optimal power levels for the emitted laser beam, and includes a beta (β) measuring unit 160, an optimal power calibration (OPC) unit 162, and a high-speed calibration unit 164. The beta measuring unit 160 is used for calculating a value of a beta variable that is an asymmetric parameter used for evaluating whether a current power level is the optimal power level of the emitted laser beam. The RF signal has an upper amplitude Al and a lower amplitude A2. The value of the beta variable satisfies an equation: β=(A1−A2)/(A1+A2).

The OPC unit 162 is used for performing a first OPC procedure at a relatively low recording speed. The high-speed calibration unit 164 is used for performing a second OPC procedure at a relatively high recording speed. The OPC unit 162 outputs an optimal power level for a relatively low recording speed, while the high-speed calibration unit 164 outputs an optimal power level for a relatively high recording speed.

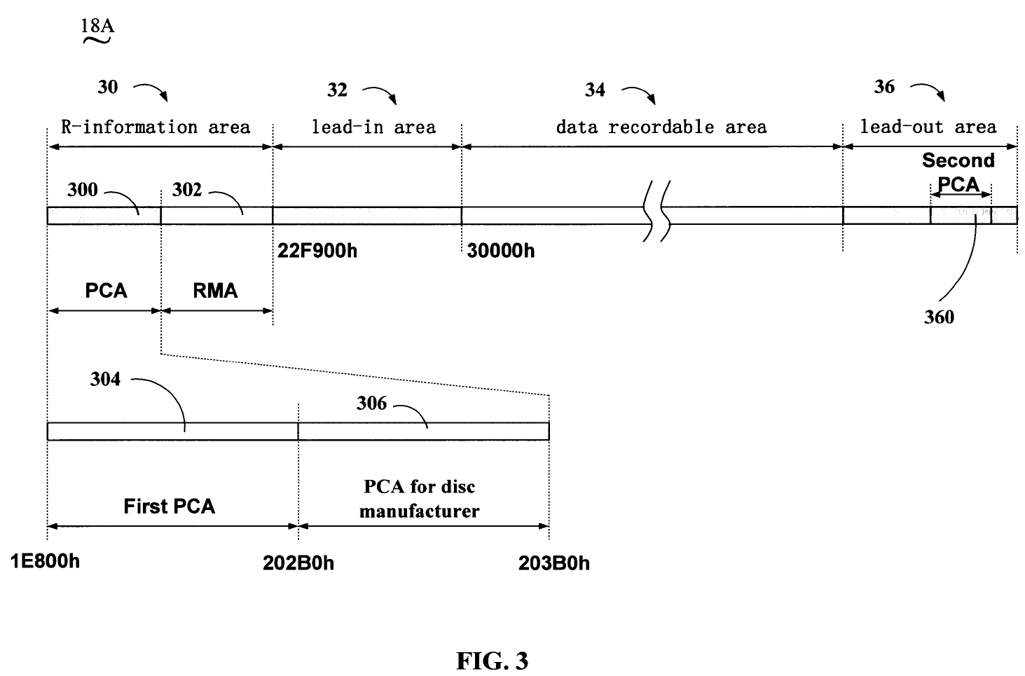

Generally, the first OPC procedure is performed at an inner area of the disc 18, and the second OPC procedure is performed at an outer area of the disc 18. The disc 18 may be any recordable medium, such as a DVD−R, a DVD+R, a DVD−RW, a DVD+RW, a CD+R, and a CD+RW. Hereinafter a DVD−R and a DVD+R are used as examples to illustrate where the first OPC procedure and the second OPC procedure are performed. Referring to FIG. 3, a schematic diagram showing a structure of a DVD−R 18A is illustrated. The DVD−R 18A includes an R-information area 30, a lead-in area 32, a data recordable area 34, and a lead-out area 36. The R-information area 30 includes a PCA 300 and a recording management area (RMA) 302. The PCA 300 includes a first PCA 304 for performing the first OPC procedure and a PCA 306 for disc manufacturers. The data recordable area 34 is used for recording data. The lead-out area 36 is used for storing specific codes that indicate an end of the data recordable area 34. Generally, there are no specifications specifying that the specific codes must fully fill up the lead-out area 36. Therefore, a blank area 360 can be obtained and used as a second PCA by shortening a length of the specific codes. The second PCA 360 is used for performing the second OPC procedure.

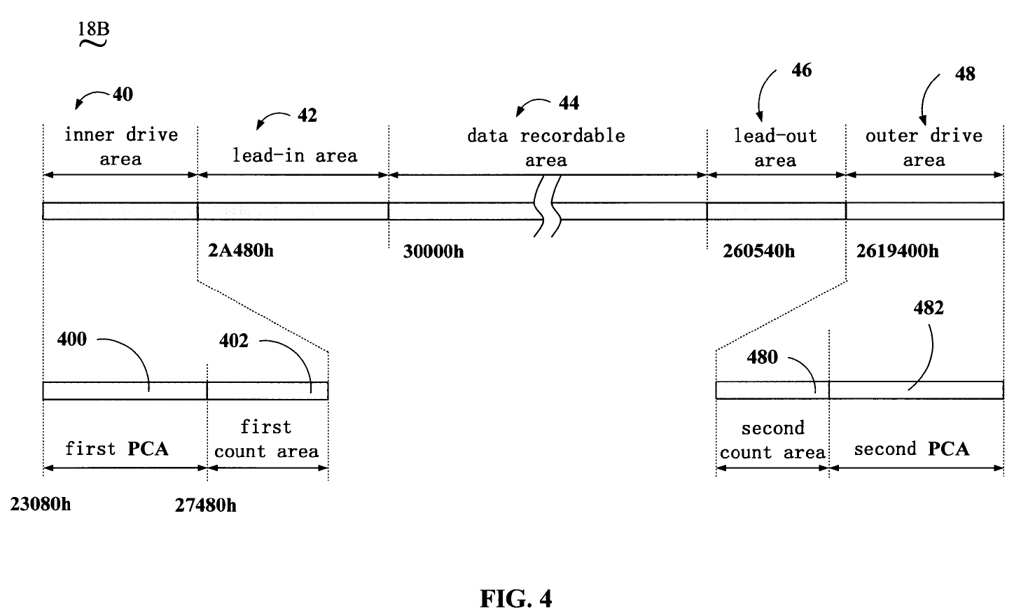

Referring to FIG. 4, a schematic diagram showing a structure of a DVD+R 18B is illustrated. The DVD+R 18B includes an inner drive area 40, a lead-in area 42, a data recordable area 44, a lead-out area 46, and an outer drive area 48. The inner drive area 40 includes a first PCA 40 for performing the first OPC procedure and a first count area 42 for storing times of performing the first OPC procedure. The data recordable area 44 is used for recording data. The outer drive area 48 includes a second PCA 480 for performing the second OPC procedure and a second count area 482 for storing times of performing the second OPC procedure.

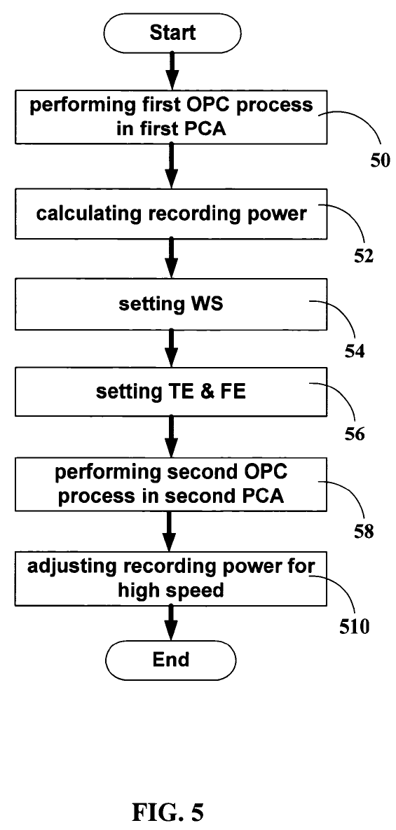

Referring to FIG. 5, a calibrating procedure of an optimal power calibration method before recording in accordance with an exemplary embodiment is illustrated.

First, step 50, the first OPC procedure is performed on the first PCA 304/400. Multiple different power levels are used to performing the first OPC procedure. The LD 100 emits a laser beam with each power level onto the disc 18 and calibration data are recorded in the first PCA 304/400 at a first recording speed. Then a value of the beta variable corresponding to each power level is obtained by the beta measuring unit 162. By comparing the value of the beta variable corresponding to each power level, a first optimal power level (hereinafter referred as to OPI) is obtained. Exemplarily, the first recording speed is 4 times (also known as 4×) a base recording speed that is specified in related industries. For example, a base recording speed for a DVD is 1350 KB/s, 4× is 5400 KB/s (4*1350 KB/s). The first recording speed can also be double (2×) of the base recording speed.

Second, step 52, a recording power level for performing the second OPC procedure is calculated based on the OPI derived from the first OPC procedure and a second recording speed for performing the second OPC procedure. For example, if the first recording speed is 4×, and the second recording speed is 8×, then the recording power level for performing the second OPC procedure is obtained by multiplying OPI with a ratio (8×/4×) of the second recording speed to the first recording speed.

Third, step 54, a write strategy (WS) for recording data on the disc 18 is set based on the OPI derived from the first OPC procedure. The write strategy defines a plurality of recording power levels and durations of different power levels. When recording data on the data recordable area 34/44, the DSP 14 reads corresponding recording power levels and durations from the write strategy, controls the ASP 12 to drive the LD 102 to emit laser beams with the recording power levels read from the write strategy, and controls the laser beam emitted by the LD 102 to emit for the corresponding durations.

Fourth, step 56, tilts of the disc 18 with respect to the laser beam and the focus errors of the laser beam are corrected based on the TE signals and the FE signals obtained in the first OPC procedure.

Fifth, step 58, the second OPC procedure is performed at the second PCA 360/482. Similarly to the first OPC procedure, the LD 100 is controlled to emit laser beams at different power levels onto the disc 18 and calibration data are recorded in the second PCA 360/482 at the second recording speed. By comparing the values of the beta variable corresponding to the different power levels, a second optimal power level (hereinafter referred as to OP2) for the second recording speed is obtained. Then the second OPC procedure is performed at a third recording speed, and a third optimal power level (hereinafter referred as to OP3) for the third recording speed is also obtained. Exemplarily, the second recording speed is 8×, and the third recording speed is 16×.

Finally, step 510, the recording power levels in the write strategy corresponding to relatively high recording speeds are modified according to the OP2 and the OP3.

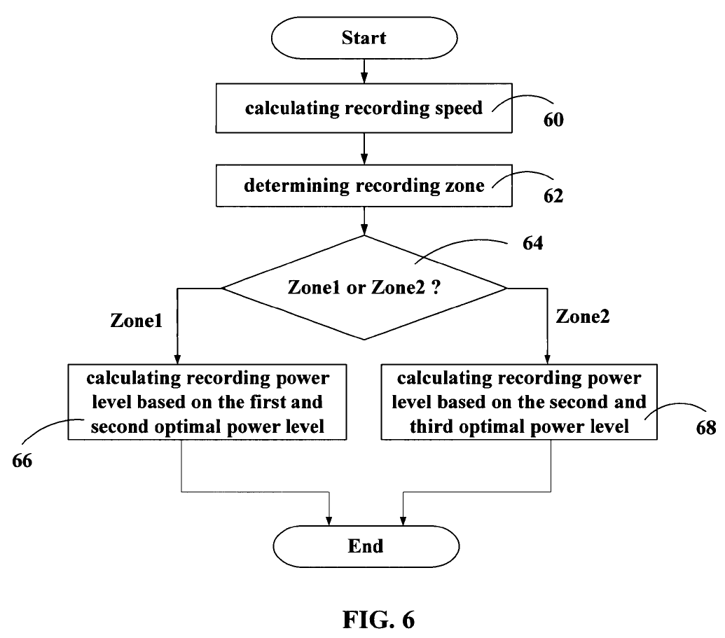

Referring to FIG. 6, a calibrating procedure of an optimal power calibration method during recording in accordance with an exemplary embodiment is illustrated.

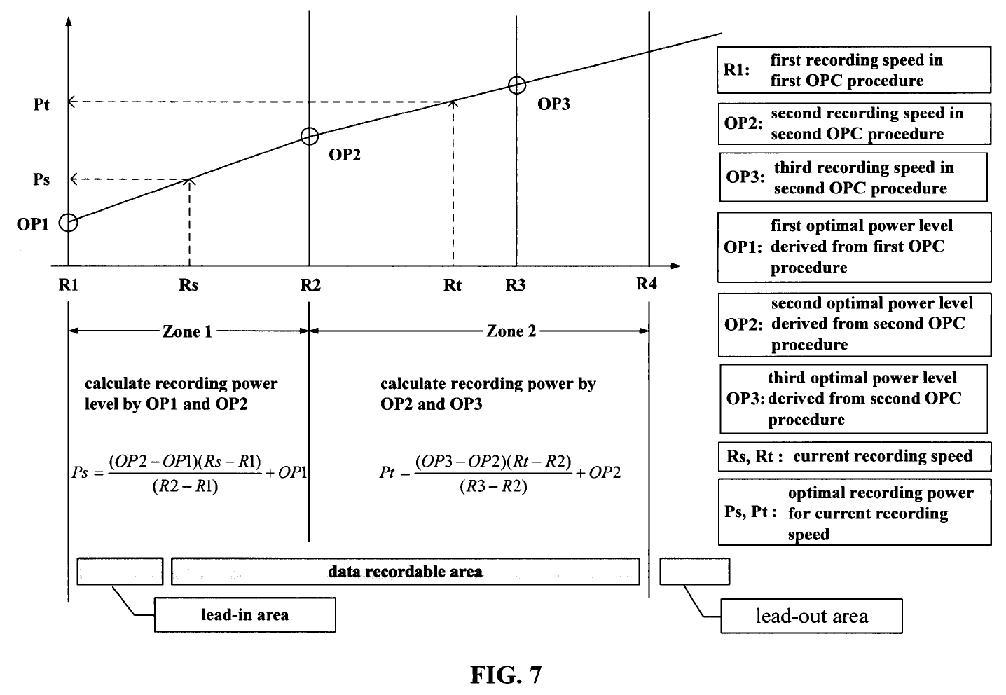

First, step 60, an appropriate recording speed before recording data on a position (hereinafter referred as to recording position) of the disc 18 is calculated. Generally, a constant linear velocity (CLV) mode or a constant angular velocity (CAV) mode is employed when the data recording apparatus 1 records data on the data recordable area 34/44 of the disc 18. Under the CLV mode, the recording speed remains at a constant level, whilst under the CAV mode, the recording speed increases as a radial distance from the recording position to a center hole of the disc 18. Since the CAV mode may use less recording time than the CLV mode, the CAV mode is more widely used in current recording apparatuses. In this embodiment, the CAV mode is used as an example for illustration. Referring also to FIG. 7, the recording speed in the CAV mode is proportional to the distance from the recording position to the center hole of the disc 18. Accordingly, the recording speed corresponding to current recording position can be obtained based on the recording speed at an innermost track of the disc 18 and the distance from the current recording position to the center hole of the disc 18. Exemplarily, the recording speed at the innermost track (referring to R1) is 4×.

Second, step 62, the disc 18 is divided into two recording zones according to the recording speeds corresponding to different recording positions. The first zone (referring to zone 1) lies from the lead-in area 32/42 that corresponds to the first recording speed (referring to R1) to the recording position that corresponds to the second recording speed (referring to R2) respectively, and the second zone (referring to zone 2) lies from the recording position that corresponds to R2, to the recording position that corresponds to the third recording speed (referring to R3).

Third, step 64, a conclusion is made as to which zone does the current recording position belong to according to the recording speed that corresponds to the current recording position.

Fourth, step 66, if the current recording position is concluded to belong to the zone 1, the current recording power level Ps is obtained by an equation: Ps=(OP2−OP1)(Rs−R1)/(R2−R1 )+OP1, wherein Rs represents the recording speed corresponding to the current recording position.

Fifth, step 68, if the current recording position is concluded to belong to the zone 2, the current recording power level Pt is obtained by an equation: Pt=(OP3−OP2)(Rt−R2)/(R3−R2)+0P2, wherein Rt represents the recording speed corresponding to the current recording position.

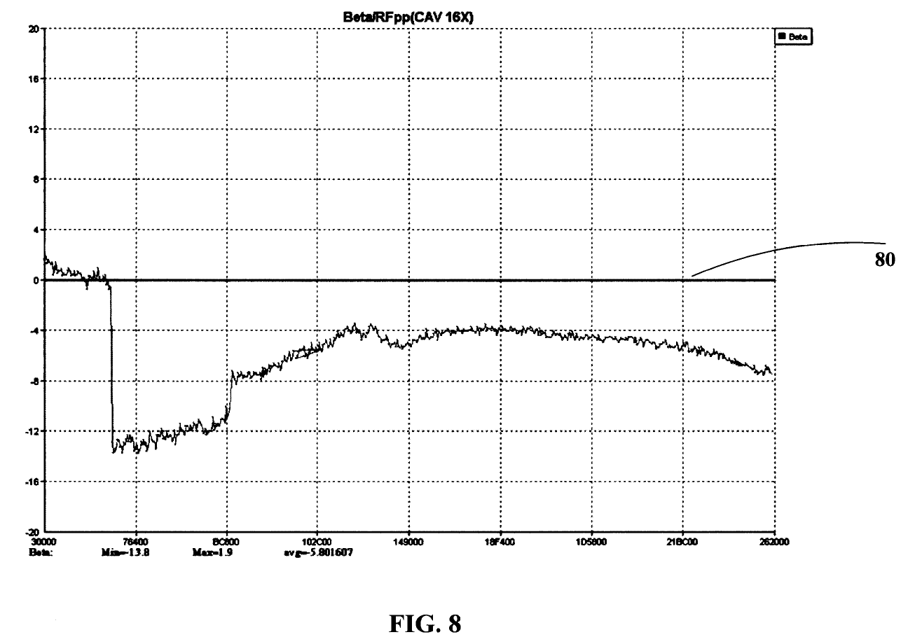

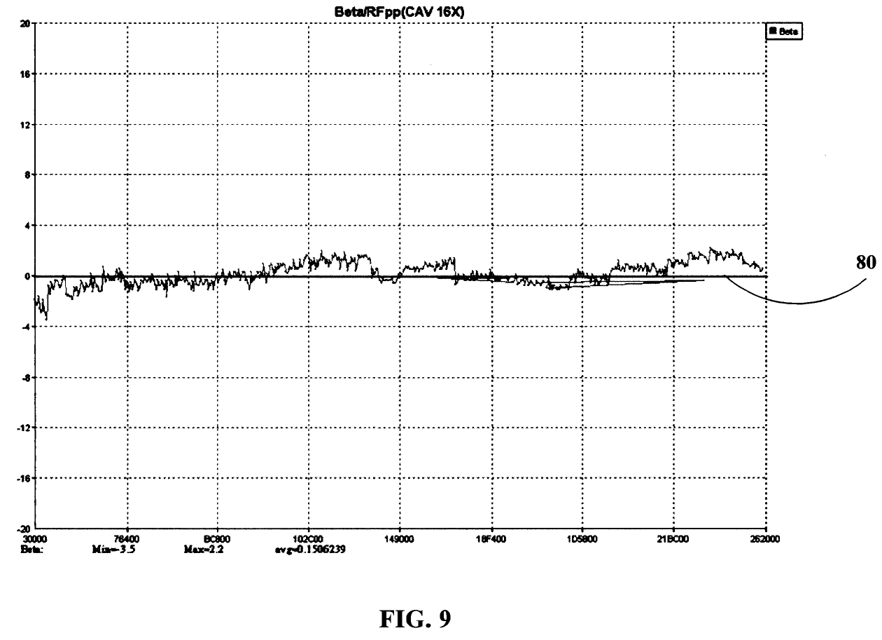

Referring to FIG. 8, values of the beta variable when recording data on different physical sectors of the disc 18 at a relatively high recording speed (eg. CAV 12×) with recording power levels obtained under a traditional optimal power calibration method are illustrated. Referring to FIG. 9, values of the beta variable when recording data on different physical sectors of the disc 18 at the relatively high recording speed with recording power levels obtained under the optimal power calibration method of FIG. 5 and FIG. 6 are illustrated. In the traditional optimal power calibration method, only the first OPC procedure is performed at the first PCA 304/400. In the optimal power calibration method illustrated in FIG. 5 and FIG. 6, not only is the first OPC procedure performed at the first PCA 304/400, but the second OPC procedure is also performed at the second PCA 360/482. It is clear that the values of the beta variable in FIG. 9 are closer to an optimal value 80 than the values in the FIG. 8. Generally, the more proper the recording power level for the relatively high recording speed is, the closer to the optimal value 80 the values of the beta variable is. Therefore, the recording power levels obtained under the optimal power calibration method of FIG. 5 and FIG. 6 are more proper than the recording power levels obtained under the traditional optimal power calibration method. That is, the optimal power calibration method of FIG. 5 and FIG. 6 may improve accuracies of the recording power levels for recording at the relatively high recording speed.

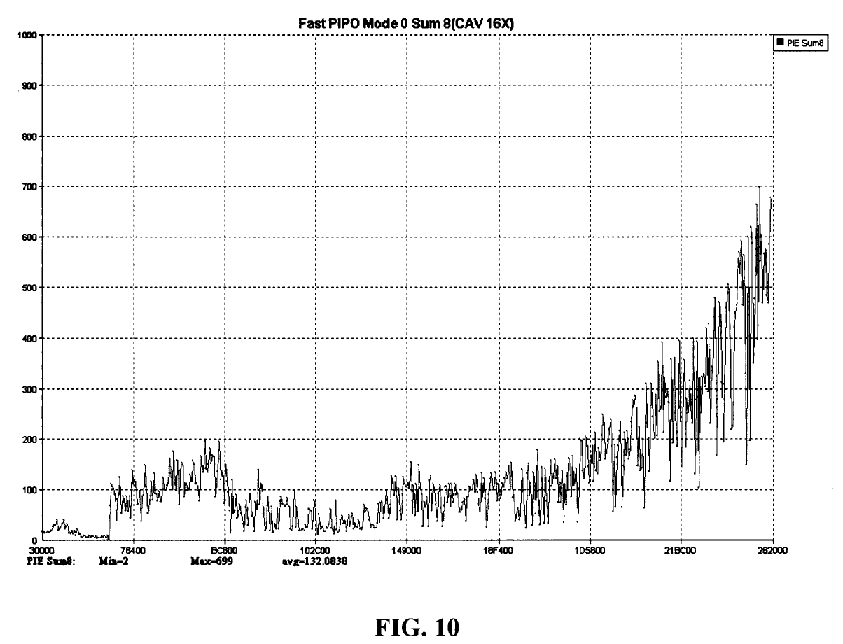

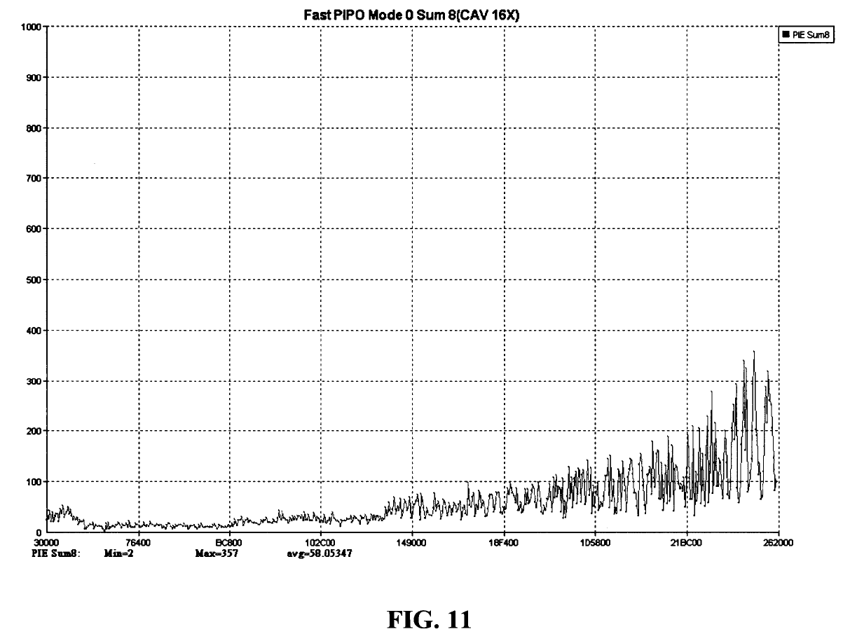

Referring to FIG. 10, values of a parity inner error (PIE) when recording data on different physical sectors of the disc 18 at the relatively high recording speed with the recording power levels obtained under the traditional optimal power calibration method are illustrated. Referring to FIG. 11, values of the PIE when recording data on different physical sectors of the disc 18 at the relatively high recording speed with the recording power levels obtained under the optimal power calibration method of FIG. 5 and FIG. 6 are illustrated. The PIE represents the number of recording errors that occur during the recording procedure. Generally, the lesser the PIE is, the more accurate the data recorded on the data recordable area 34/44 are. It is clear that the values of the PIE in FIG. 11 are lesser than the values of the PIE in FIG. 10. Therefore, the optimal power calibration method of FIG. 5 and FIG. 6 may improve an accuracy of recording.

In the above embodiments, the times of performing the second OPC procedure is not limited to two, and may be more than two. In this instance, the number of the optimal power levels derived during the second OPC procedures may be more than two, and the number of the recording zones is more than two.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. An optimal power calibration method, comprising steps of:
performing a first optimal power calibration procedure at a first power calibration area with a first recording speed to obtain a first optimal power level corresponding to the first recording speed;
performing a second optimal power calibration procedure at a second power calibration area with a second recording speed to obtain a second optimal power level corresponding to the second recording speed, the second recording speed being higher than the first recording speed; and
determining an optimal recording power level corresponding to a current recording speed based on the first optimal power level and the second optimal power level.

2. The optimal power calibration method as claimed in claim 1, wherein the first recording speed is four times a base recording speed, and the second recording speed is eight times the base recording speed.

3. The optimal power calibration method as claimed in claim 1, further comprising a step of performing the second optimal power calibration procedure at the second power calibration area with a third recording speed to obtain a third optimal power level corresponding to the third recording speed, the third recording speed being higher than the second recording speed.

4. The optimal power calibration method as claimed in claim 3, wherein the third recording speed is sixteen times a base recording speed.

5. The optimal power calibration method as claimed in claim 4, wherein the step of determining comprising steps of:
determining the current recording speed;
determining relationships between the current recording speed and the first recording speed, the second recording speed and the third recording speed; and
calculating the optimal recording power level corresponding to the current recording speed by interpolation.

6. The optimal power calibration method as claimed in claim 1, wherein each of the first optimal power calibration procedure and the second optimal power calibration procedure comprises steps of:
controlling an optical pick-up unit to emit light beams with different power levels, the light beams being focused on a disc;
receiving reflected light beams from the disc and generating electrical signals based on the reflected light beams;
generating radio frequency signals based on the electrical signals;
converting the radio frequency signals into digital signals;
calculating values of a beta variable, the beta variable indicating asymmetry of the radio frequency, each value of the beta variable corresponding to one of the different power levels; and
comparing the values of the beta variable to determine which one of the different power levels is optimal.

7. A data recording apparatus, comprising:
an optical pick-up unit for emitting light beams to be focused on a disc, detecting reflected light beams from the disc and for generating electrical signals based on the reflected light beams;
an analog signal processor for generating radio frequency signals based on the electrical signals;
a digital signal processor for converting the radio frequency signals into digital signals; and
a firmware connected to the digital signal processor, the firmware constructed for sending commands to the digital signal processor, the commands being transformed to analog signals by the digital signal processor and then fed to the analog signal processor to control the optical pick-up unit to emit light beams to perform a first optimal power calibration procedure at a first recording speed at a first power calibration area to obtain a first optimal power level and perform a second optimal power calibration procedure at a second recording speed at a second power calibration area to obtain a second optimal power level, the first power calibration area being arranged at an inner area of the disc, the second power calibration area being arranged at an outer area of the disc, the second recording speed being higher than the first recording speed.

8. The data recording apparatus as claimed in claim 7, wherein the firmware comprises an optimal power calibration unit for performing the first optimal power calibration procedure, and a high-speed calibration unit for performing the second optimal power calibration procedure.

9. The data recording apparatus as claimed in claim 8, wherein the high-speed calibration unit is constructed for performing a third optimal power calibration procedure with a third recording speed at the second power calibration area to obtain a third optimal power level.

10. The data recording apparatus as claimed in claim 9, wherein the third recording speed is higher than the second recording speed.

11. The data recording apparatus as claimed in claim 9, wherein a recording power level for recording data onto the disc is determined by interpolation based on the first optimal power level, the second optimal power level and the third optimal power level.

12. The data recording apparatus as claimed in claim 9, wherein the third recording speed is 16 times a base recording speed.

13. The data recording apparatus as claimed in claim 7, wherein the firmware comprises a measuring unit for measuring an asymmetric parameter of the radio frequency signals, the asymmetric parameter being used for evaluating whether a power level is an optimal power level during the first optimal power calibration procedure and the second optimal power calibration procedure.

14. The data recording apparatus as claimed in claim 13, wherein the optical pick-up unit is controlled to emit multiple light beams with different power levels, the measuring unit calculates a separate parameter value for each power level, and which one of the different power levels is the optimal power level is determined by comparing the parameter values for the different power levels.

15. The data recording apparatus as claimed in claim 7, wherein the first recording speed is four times a base recording speed, the second recording speed is eight times the base recording speed.

16. The data recording apparatus as claimed in claim 7, wherein the optical pick-up unit comprises a laser diode for emitting the light beams and a photo diode for detecting the reflected light beams and generating the electrical signals based on the reflected light beams.

17. A storage medium for recording a computer-executable program, the program having a computer executable steps of:
performing a first optimal power calibration procedure at a first power calibration area with a first recording speed to obtain a first optimal power level corresponding to the first recording speed;
performing a second optimal power calibration procedure at a second power calibration area with a second recording speed to obtain a second optimal power level corresponding to the second recording speed, the second recording speed being higher than the first recording speed; and
determining an optimal recording power level corresponding to a current recording speed based on the first optimal power level and the second optimal power level.

18. The storage medium as claimed in claim 17, wherein the program has the computer executable a step of performing the second optimal power calibration procedure at the second power calibration area with a third recording speed to obtain a third optimal power level corresponding to the third recording speed, the third recording speed being higher than the second recording speed.

19. The storage medium as claimed in claim 18, wherein the program has the computer executable steps of:
determining the current recording speed;
determining relationships between the current recording speed and the first recording speed, the second recording speed and the third recording speed; and
calculating the optimal recording power level corresponding to the current recording speed by interpolation.

20. The storage medium as claimed in claim 19, wherein the first recording speed is 4 times a base recording speed, the second recording speed is 8 times the base recording speed, and the third recording speed is 16 times the base recording speed.
